(19) United States
(12) Patent Application Publication
(10) Pub. No.: US 2022/0058905 A1
(43) Pub. Date: Feb. 24, 2022

(54) METHODS AND APPARATUS OF ASSIGNING PRIVILEGED USERS TO ACCESS CONTROL SYSTEMS

(71) Applicant: Ellenby Technologies, Inc., Woodbury Heights, NJ (US)

(72) Inventors: Aaron H. Dobbins, Cherry Hill, NJ (US); Brian D. Stang, Bel Air, MD (US); Scott Barnes, Wenonah, NJ (US)

(21) Appl. No.: 16/997,072

(22) Filed: Aug. 19, 2020

(51) Int. Cl. G07C 9/00

(52) U.S. Cl. CPC G07C 9/00912; G07C 2009/00984; G07C 2009/00769; G07C 9/00571

(57) ABSTRACT

Aspects of securely assigning new authorized users to networked equipment for the purposes of gaining entry into that equipment or accessing valuable data from that equipment are addressed. High security access key fobs are assigned to individual users and serve as proxies for their identities. A new user creation fob or other secure two-factor authentication method is used to verify the identity of a newly enrolled or newly modified user.

### FIELD

The present invention relates generally to improved methods and apparatus for assigning privileged users to access control systems, and more particularly to such methods and apparatus applied to networks of electronic smart safes which are accessed by authorized users who among other jobs access such safes to pick up valuables therefrom and transport those valuables to another location, such as a bank, for example.

### DESCRIPTION OF THE RELATED ART

Examples of background art include U.S. Pat. No. 5,321,242A assigned to Brinks, Inc. which is titled “Apparatus and Method for Controlled Access to a Secured Location” which addresses aspects of a system for authorizing users to access devices such as automated teller machines (ATMs) or pay telephones, without a key or combination to open a lock securing said device by utilizing a present access code, a personal identification number (PIN) of a technician and the identification number of a particular portable terminal.

Another such item is Australian Patent No. 2006307 977B2 assigned to Dormakaba Schweiz AG addressing a “Method for Controlling the Locking of a Lock, and Lock” which addresses a method for controlling an electronic lock in which a user authenticates himself to an electronic lock, the electronic lock displays a question, the user transmits the question to a central station, the central station computes and transmits back the answer and the user introduces the answer into the lock which verifies if the answer is correct and if it is, the lock is opened. An acknowledgement code is displayed by the lock and transmitted by the user to the central station by means of a mobile device.

U.S. Pat. No. 5,774,058 assigned to Vindicator Corp addresses a “Remote Access System for a Programmable Electronic Lock” in which insertion of a key and login permission allow access of a computer to an electronic lock via a communication channel According to one arrangement, the user located remote from the lock may operate the lock from the remote location.

U.S. Pat. No. 8,970,344 assigned to CompX International, Inc. addresses a “Method and System for Data Control in Electronic Locks” in which a plurality of electronic locks are connected to a central server over a network in which an 802.11 WiFi communications module is selectively powered on and off to conserve power resources. An electronic access control system is addressed which allows efficient data exchange between a central server and a plurality of electronic locks.

Cencon 5.1.0.3494 Reference Manual 4 Jun. 2014 (https://dormakaba.com/resource/blob/572834/2fcbe768cdf368e4d9c50e077f3/cencon-reference-manual-pdf-data.pdf) and CenTran 5.1.0.3494 XML Programming Reference Manual 4 Jun. 2014 (https://dormakaba.com/resource/blob/572830/cd65063a382c5e48102786566af39191/centran-programming-reference-manual-2-pdf-data.pdf) address the management of large deployments of devices, such as ATMs, networked with a central server as addressed further below.

The process of creating new users authorized to use a secure piece of equipment, such as an electronic safe, can often present a security vulnerability. It is desirable to maintain a list of authorized users on a networked server which then informs networked security equipment of those authorized users. These types of systems are easy to centrally maintain and monitor, especially for industries that have frequently changing authorized users with time. It is particularly relevant to the Cash-In-Transit (CIT) industry as it relates to armored car drivers assigned to collect cash from retailers with on premises networked smart safe equipment that electronically validates cash deposits.

Creating a new smart safe user on a networked server exposes a vulnerability in the security of the equipment if that user was created for a malicious purpose by hackers. Hackers, for instance, can create a credential that will gain them access to a smart safe to avoid dealing with more difficult physical attacks on the safe itself.

Methods to reduce this security vulnerability can be implemented on the network side, the equipment side, or both. On the networked server, there are several known methods to protect against hackers. Countermeasures may include the use of firewalls, two factor authentication (2FA), and restrictions on IP addresses of computers that can access server data.

Hackers unfortunately have consistently remained clever in finding ways of overcoming obstacles of network security which has made it increasingly important to ensure there are countermeasures in place on the equipment side as well.

Security of the equipment can be enhanced to require 2FA whereby one secure credential alone is not sufficient to gain access. The second factor could be the credential from a second authorized user, a user's secret personal identification number (PIN) code in addition to a fob credential, or a generated temporary code such as a one-time code (OTC).

Adding extra security on the equipment side typically extends the time that users spend in the authentication process. The activity of accessing valuables within a smart safe can be stressful as both the cash or other valuables being collected and the personnel collecting cash are vulnerable to attack. Consequently, it is desirable to make the authentication process at the equipment quick and efficient. Security equipment manufacturers often need to make concessions in security to allow for easier configuration and user access to their systems.

One common concession is to issue fobs that contain both a user identifier and a permission embedded within the fob. This approach puts the burden of security on the fob registration process. The equipment need only read the permission level reported in the fob to see if that user can access privileged safe data or gain entry. In a networked system, it is disadvantageous to assign permissions in a fob since the fob would have to be reprogrammed any time the permission level changes. In contrast, it is advantageous for a networked system to maintain user permissions on the networked server to allow for flexibility in changing permission level as business needs change.

The highest level of security for equipment is achieved when the equipment is informed explicitly of all authorized users. In this approach, an allow list of approved users is maintained and stored within each piece of equipment. If a user credential is presented to the equipment that is not on the allow list, it is denied. This practice is in contrast to the fob model discussed above where the fob itself contains the privilege level. To administer an allow list across a field base of hundreds or even thousands of pieces of networked security equipment can be quite difficult and costly.

Dormakaba manages large deployments of connected security equipment such as automated teller machines (ATMs) with their Cencon lock system. See the Cencon Version 5 System Reference Manual cited above. User allow lists are supported by their “Bank Mode” of operation. To add users to an ATM's allow list, one of two methods are available. First, a system administrator can specially program a supervisor audit (SA) fob with the data needed to place the new user record into the ATM. The ATM needs to read the SA fob with the new user fob to register the new user. For every operation of adding or deleting users, the SA fob requires unique programming by the administrator and then redeployment to the ATM requiring the update.

A second method is to use a network interface box that allows the Cencon lock to communicate to a networked server with a database of valid users. Users can be added or deleted over the networked link without the aid of the SA fob with this interface box option (Cencon O2 system).

Managing allow lists in the manner of a Cencon lock system with the SA fob offers a highly secure method of adding users to locks, but that method is labor intensive and may be prohibitive for companies with dynamically changing user lists. Eliminating the need for the SA fob in managing allow lists and relying on a secure networked server has the drawback of putting additional burden on the server security to prevent the malicious creation of false users or modification of trusted user permissions by hackers. It also suffers from increased cost and software complexity involved in installing a separate communication box inside an ATM and running a proprietary software client on the ATM computer.

Presumably, it is for this reason that the Cencon system reserves their allow list “Bank Mode” of operation for a select group of users that tend to be permanently associated with only a couple of ATMs located within the same physical bank. For those in the CIT business that refill ATMs and those in the service business that fix ATMs, they offer an alternate approach where the permission is embedded in a fob. The fob and an OTC are necessary to gain entry. This scheme avoids the need to maintain an allow list or preregister users on each piece of equipment. The administrator must program each user key with the corresponding permissions inclusive of time of day for equipment access, maximum number of door access events per day, and authorized geographic region or regions the user can access ATMs within. In this way, region codes are used as a convenient compromise to explicit allow lists of allowable machines.

If a CIT guard loses a key, the system relies on 2FA of the OTC at the security equipment to maintain integrity. The drawback of this style of 2FA of a user's credentials is that the OTC must be gathered during every visit to a piece of equipment adding time and complexity to every access operation.

In consequence, the art continues to seek improvements in striking the correct balance between providing cost effective security while maintaining ease and speed of use where the period of vulnerability to attack should be minimized if possible.

### SUMMARY

It is one object of this invention to alleviate some of the security burden on a networked server while still permitting the flexibility of using that networked server for a large deployment of networked security equipment supporting allow lists.

Another objective is to present a method of pre-registering new privileged networked safe users first on a networked server database and then completing the registration at the equipment using an additional security credential. After registration is completed, the 2FA on each user's identity is removed to avoid additional time onsite and complexity of managing trips to connected equipment.

Another objective is to present a novel authenticator fob security credential that can be used at the safe for registering new privileged users for any safes managed by a particular company. In this approach, the authenticator fob enables creation of new users as addressed further herein.

Yet, another objective is to define two secure methods of new privileged user registration to a piece of networked security equipment: one that is initiated by a central administrator and then completed locally at the equipment, and one that is performed locally at the equipment.

Another objective is to define a secure method of modifying existing privileged user credentials to a piece of networked security equipment: one that is initiated by a central administrator and completed at the equipment.

One aspect of the invention addresses a system comprising a networked central database, an electronic safe, and an electronic user fob: the networked central database storing safe users and associated unique identification numbers; the electronic safe controlled by an electronic safe controller; an electronic fob reader for reading electronic user fobs, wherein the electronic safe is at least in occasional communication with the networked central database by way of a network connection, a list of allowed safe users and corresponding access rights are exchanged from the networked central database to the safe, the controller authenticates safe users for the purpose of granting access to secure data stored within the controller, door access, or both; the electronic user fob contains at least the user's unique identification number, and wherein, a multi-factor authentication method is required at the safe to accept the electronic user fob on the first access attempt by that fob on that safe, a first factor authentication being presentation of the electronic user fob at the electronic safe; and the user is authenticated with the electronic user fob alone on subsequent electronic safe access.

Another aspect of the invention addresses a system comprising a networked central database, an electronic safe, an electronic user fob, and an authentication fob: the networked central database storing electronic safe users and associated unique identification numbers; the electronic safe controlled by an electronic safe controller and having an electronic fob reader for reading electronic user fobs; the electronic safe communicating at least occasionally with the networked central server by way of a network connection, wherein a list of allowed safe users and corresponding access rights are exchanged from the networked central database through the network to the electronic safe; the controller authenticates safe users for the purpose of granting access to secure data stored within the controller, door access, or both; the electronic user fob contains at least the user's unique identification number; an authentication fob is used to expedite the authentication of new electronic user fobs by requiring presentation of the authentication fob at the safe to accept the electronic user fob on the first access attempt by that fob at that safe, and the user may authenticate with the electronic user fob alone on subsequent safe access.

Other aspects, features and embodiments of the disclosure will be more fully apparent from the ensuing description and appended claims.

### BRIEF DESCRIPTION OF THE DRAWINGS

FIG. 1 illustrates a networked system of electronic smart safes which communicate with a central server to implement methods and apparatus of assigning privileged users in accordance with a first embodiment of the present invention;

FIG. 2 illustrates a first process of user registration in accordance with a first embodiment of the present invention;

FIG. 3 illustrates a process of preprogramming a fob and storing the data at the server of FIG. 1 which is preferably used in conjunction with the first process of user registration of FIG. 2;

FIG. 4 shows a flowchart illustrating an exemplary user experience at an electronic smart safe in accordance with the present invention;

FIG. 5 illustrates a process of adjusting user permissions in accordance with the first embodiment of the present invention;

FIG. 6 illustrates a process of full user registration at the safe in accordance with a second embodiment of the present invention;

FIG. 7 illustrates a process of user interaction at an electronic smart safe where the second registration process of FIG. 6 is completed utilizing a user fob of higher privilege to complete the first-time registration process;

FIG. 8 illustrates a process of user interaction at an electronic smart safe where the registration process of FIG. 6 is completed with an authentication fob;

FIG. 9 illustrates a process of user interaction at an electronic smart safe where the registration process of FIG. 6 is completed with a temporary code;

FIG. 10 illustrates presently preferred control electronics for an electronic smart safe supporting user registration in accordance with both embodiments of the present invention; and

FIG. 11 illustrates an interaction between the safe, server, administrator and user during the registration process in accordance with the first embodiment of the present invention.

### DETAILED DESCRIPTION

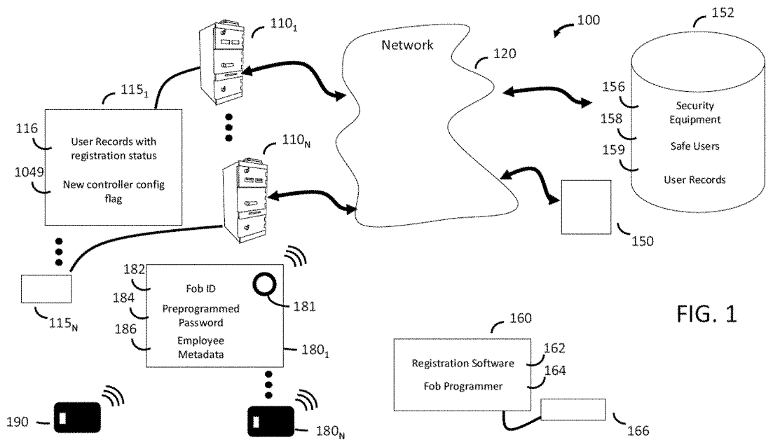

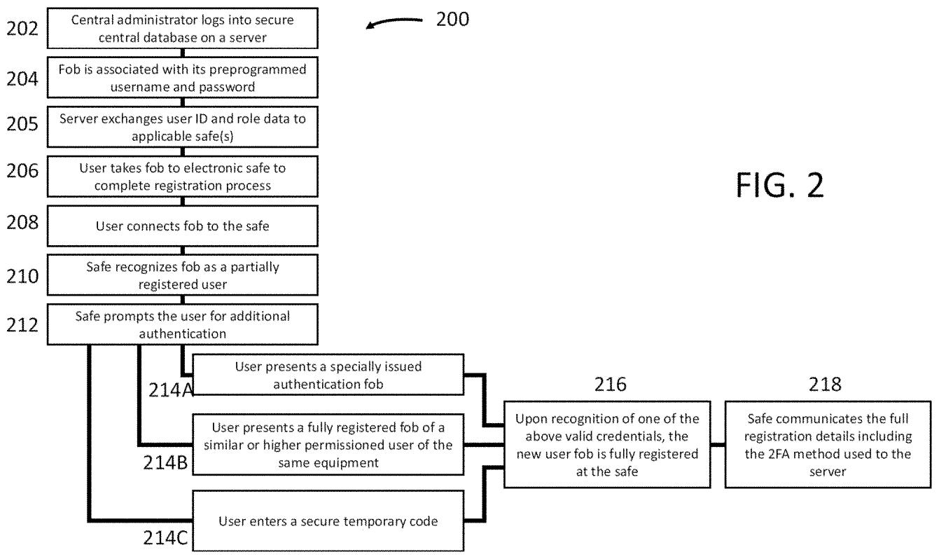

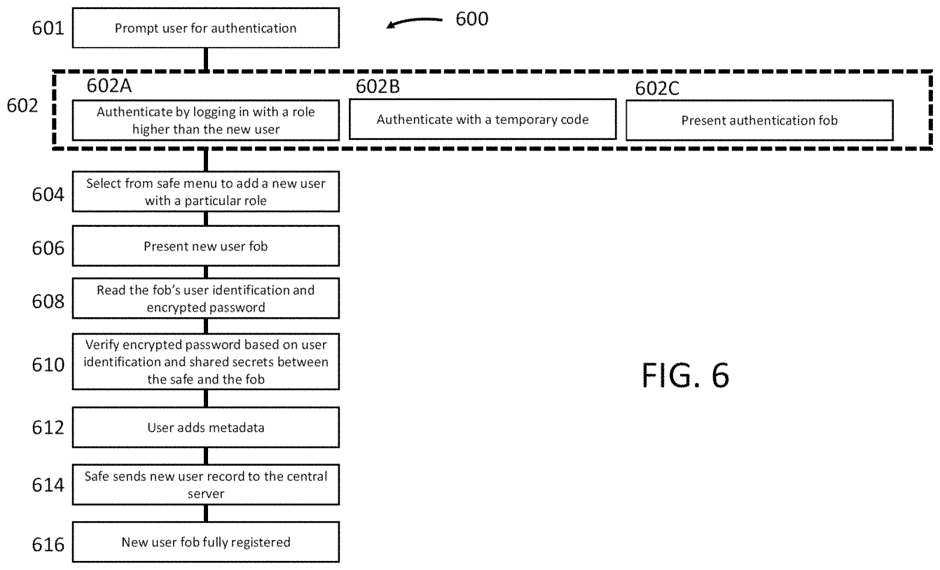

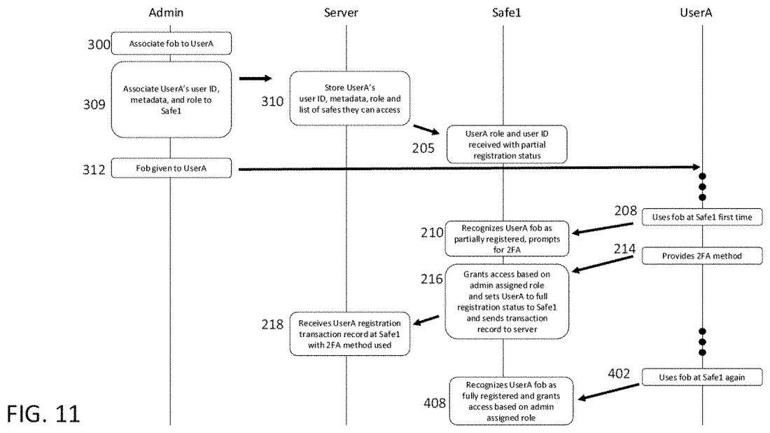

The present invention presents a secure method and apparatus for adding users to one or more networked pieces of security equipment that are centrally administered. In the context of this disclosure, the security equipment described is in the form of a smart safe, but the disclosure should be understood as equally applicable to other types of security equipment such as electronic storage lockers or the like. FIG. 1 shows a networked system 100 having a plurality of electronic smart safes 110₁ . . . 110_{N} (collectively 110) each containing a respective safe controller 115₁ . . . 115_{N} networked utilizing network 120 with a central server database 152. An administrator access point 150 permits viewing and modifying data from the database 152 which stores data such as lists of security equipment 156, such as fobs, authentication fobs, electronic smart safes and the like; lists of authorized equipment users 158 including their roles or in other words the equipment that they are authorized to interact with and the nature of that interaction; as well as user records 159 as addressed further below. A plurality of user fobs 180₁ . . . 180_{N} (collectively 180) are utilized as part of a two-part registration process as discussed further below in connections with a discussion of FIGS. 2-5, 10 and 11 or a full registration at the safe and a one-part process of a second embodiment as discussed in conjunction with FIGS. 6-10.

System 100 also preferably includes a programming terminal 160 with keyboard 166. The programming terminal includes registration software 162 for programming fobs and a fob programmer 164. Terminal 160 is utilized by the system administrator in programming fobs 180 and authenticator fobs 190. While one authenticator fob 190 is shown for ease of illustration, it will be recognized that in a typical system more than one authenticator fob will be employed though the number will be significantly less than the number of fobs 180. The programming terminal 160 could also serve as an administrator access point 150.

In the first embodiment, a two-part registration process 200 shown in FIG. 2 is employed. In a first step 202, a central administrator logs into a secure database, such as secure database 152 of FIG. 1 utilizing access point 150 of FIG. 1, for example. The database 152 contains records of all security equipment 156 and equipment users 158 including their roles or permissions. New users are assigned an electronic key fob or fobs, such as one or more of the fobs 180. Preferably, each user is assigned a single key fob. Electronic fobs can take the form of a wireless fob, for instance, using Bluetooth low energy (BLE), near field communication (NFC), WiFi, Zigbee, Optical link, or various other standard RF communications protocols. The wireless fob can take the form of a smart phone, tablet, beacon, or device that houses an appropriate transceiver. Other possible electronic key fobs take the form of a conductive path style fob such as a Maxim Semiconductor iButton™ fob, a USB based key fob, or the like.

Each electronic fob is provided to the administrator with a uniquely programmed and unalterable identification (fob ID) number 182 which advantageously is employed as a proxy for the user name. The fobs also have a unique preprogrammed password 184 which is preferably encrypted, such that a private key and decryption algorithm or cryptographic hash function is necessary to validate the plaintext password. Because the user ID number and passwords are only ever machine exchanged, there is no need for either to be easy to remember. Thus, the password 184 can be as long and strong as desired. In accordance with a presently preferred embodiment of the invention, the plaintext password is preferably a random 128-bit number and is preferably derived from the fob ID number and a shared secret in the form of a private key shared between the electronic safe and the programming terminal 160. The fob ID number is preferably the 48-bit unique BLE media access control (MAC) address or the 48-bit unique identifier code found in all iButton™ chips.

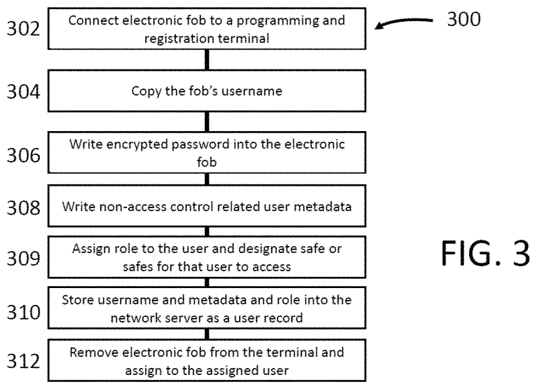

In step 204, the administrator associates a fob, such as one of the fobs 180, with its described preprogrammed fob ID number to a particular equipment user in a process of preregistration 300 further illustrated in FIG. 3.

A preregistration process 300 in accordance with one presently preferred embodiment proceeds as follows.

First, in step 302, the administrator connects the electronic fob to a programming and registration terminal, such as terminal 160 of FIG. 1 which employs the registration software 162 and fob reader 164 as follows.

In step 304, the registration software copies the fob's id number which may also be referred to as its username.

In step 306, the registration software also writes the encrypted password into the electronic fob. Preferably, the encrypted password is derived from the user id and a cryptographic shared secret between the fob and the equipment for which the fob is to be used with.

In step 308, the administrator optionally uses registration software to write on the fob any non-access control related user metadata 186, such as employee name, employee ID number, a truck number of a truck to be utilized by the employee, a route number, employee email address, employee cellular phone number and the like.

In step 309, the administrator assigns permissions to the user record including access rights and restrictions for a piece of networked security equipment or a group of networked pieces of security equipment.

In step 310, the registration software stores the username and metadata into the networked server as a user record 158a.

In step 312, the administrator removes the electronic fob from the terminal and assigns it to the assigned user.

An advantage to deriving the programmed encrypted password from the fob ID number and a cryptographic shared secret in step 306 is that there is no need to store the encrypted password on the networked server in step 310. If the encrypted password is not derived deterministically from the ID number, this encrypted password would also need to be stored on the server and synchronized with the safe equipment.

Returning to FIG. 2, in step 205, the user record data is exchanged with the safe or group of safes which the administrator has assigned the user access. Any safe that receives a user record will preregister that user in the safe.

After preregistration is completed, the user can take the newly assigned access fob to any of the safes to which the user was assigned by the administrator in step 309. At each safe, in step 206, the user completes the registration process performing the following tasks:

in step 208, the user connects the electronic fob to the safe or otherwise uses the fob to communicate with the safe;

in step 210, the safe recognizes the fob as a pre-registered user, but identifies this use as the first time at the safe;

in step 212, the safe prompts the user for authentication following one of the below 2FA methods:

in step 214A, the user presents a specially issued authentication fob given to the user to expedite full registration;

alternatively, in step 214B, the user presents a fully registered electronic fob of a similar or higher permissioned user of the same equipment; or

in step 214C, the user enters a secure temporary code, such as an OTC, for example.

In step 216, upon recognition of one of the above valid credentials, the new user fob is fully registered by the safe.

In step 218, the safe communicates the full registration details inclusive of the 2FA method used (along with the previously registered user ID from step 214B if applicable) to the networked database 152.

Two-part registration in the manner of process 200 eliminates the potential of a hacker successfully adding new safe users on the networked server to be later exploited to gain access. It also provides a quick and secure method of fully authorizing the new user on each piece of equipment without adding too much time and tediousness to that first visit to each newly registered safe.

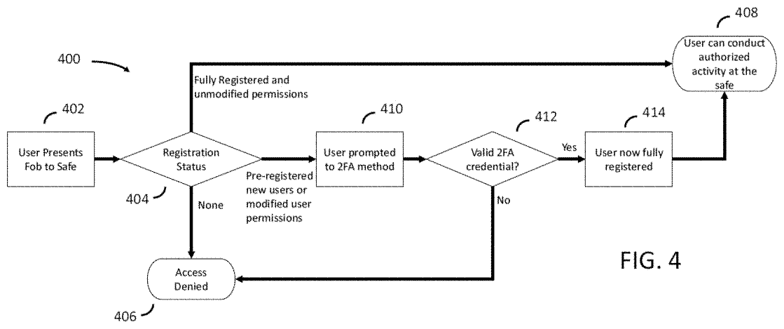

FIG. 4 illustrates the ease of the first visit while summarizing the process 400 of user interactions on the first and subsequent visits to the electronic smart safe in the first embodiment of the invention. In step 402, the user presents a fob to the safe. For example, the user clicks a button, such as button 181 on the fob 180 causing the fob to communicate using BLE transmission which is received by the safe. The registration status of the fob is evaluated by the safe in step 404. If the fob is not recognized as either status (1) fully registered with unmodified permissions or as status (2) belonging to a preregistered new user or to a registered user with modified permissions, then access is denied in step 406. If the registration state is determined to be status (1) in step 404, then the user is granted access to conduct authorized activity at the safe in step 408. One example of such activity is for a CIT employee to open the safe with the fob and remove any stored valuables, such as cash from the safe. Another example is for an authorized service person to open the safe to perform service thereon.

If in step 404, the status was determined to be status (2), then in step 410, the user is prompted to provide the second factor of two factor authentication (2FA) as discussed above in connection with steps 212, 214A, 214B, 214C and 216 of process 200. In step 412, if a valid 2FA credential is presented, then in step 414, the user is now fully registered and can conduct authorized activity in step 408.

If in step 412, it is determined the 2FA credential was not valid, access is denied in step 406.

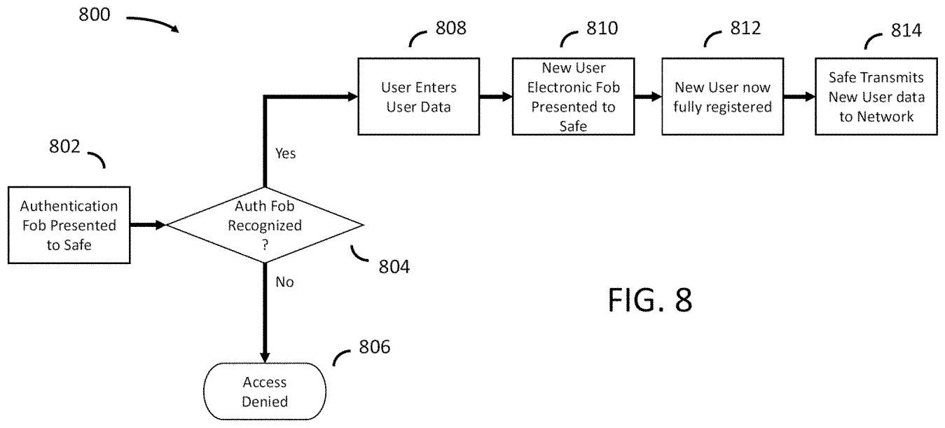

The authentication fob, such as fob 190 utilized in step 214A of process 200, is intended to be protected by the company responsible for the servicing of the safes, typically a CIT company. Thus, authentication fobs will typically only be made available to new staff that are visiting safes for the first time and upon completion of those visits will be retrieved from them. The authentication fob can take the form of an RF fob or conductive path fob. Authentication fobs are typically registered to a collection of deployed equipment ahead of time. When one is presented to such a safe, the safe is prompted to accept a new user credential or the credential of a user is modified as discussed above in connection with FIG. 2 or below in connection with FIGS. 6 and 8. Preferably, when a valid authentication fob is presented to the safe, the safe will allow for the creation of one particular type of user with predetermined access control privileges. For example, presenting an authentication fob results in the association of any following key fob with privileges of a CIT user. Authenticator fobs alternatively may restrict new users to a subset of available permission levels to prevent for example, a CIT user creating or assigning a new service person credential.

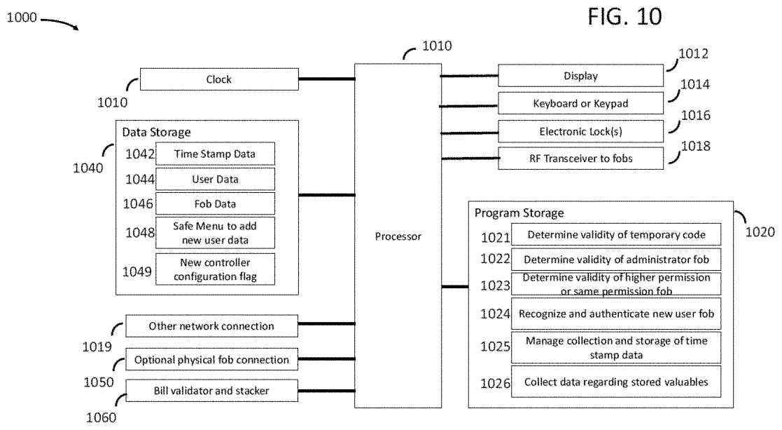

It should be noted that for newly installed equipment, all safe users assigned to the safe can be fully registered in advance so the above process is only necessary when new users are added to existing equipment. Preferably, when adding a user list to a brand new safe or a new safe controller that is replacing an existing safe controller, an alternate method can be used that bypasses the need to have a second factor authentication while still maintaining the system's security. One such method is to set a new controller configuration software flag (1049 in FIGS. 1 and 10) in the safe controller at the factory before it ships inside a new safe or to be used as a replacement controller for an existing safe. On power up, the safe controller will see the new controller configuration flag is set which will permit the reception of a user list from the server and will immediately fully register all users received. The new controller configuration flag will be cleared after the user list is sent down that first time. Alternative methods of clearing the new controller configuration flag could be after a set period of time from power up as measured by the system clock, by a privileged safe user such as the service person or installer of the safe once user list is confirmed, an administrator after the safe has been placed into service, or after a certain number of transactions occur at the safe. Once the new controller configuration flag is cleared, any further updates to the user list from the server will only appear as partially registered and will require the described 2FA methods to fully register those new or modified users.

Temporary codes preferably take the form of OTCs. These OTCs can be generated by a central administrator in response to a randomly generated challenge code displayed at the safe. This central administrator function can be either automated by a program that provides the challenge code response or can be manually implemented, for example, in response to a conversation with an individual that has access to the response code generation tool. Temporary codes may also take the form of a code of the day which may suitably be implemented with a coordinated shared secret lookup table that advances both on the safe and is synchronized with a central administrator tool such that access codes for a particular safe on a particular day can be generated in advance of a trip. Temporary codes may suitably be exchanged between the administrator and the safe user either by phone call, web software tool, a printed report generated in advance, or some other secure manual or automated exchange mechanism.

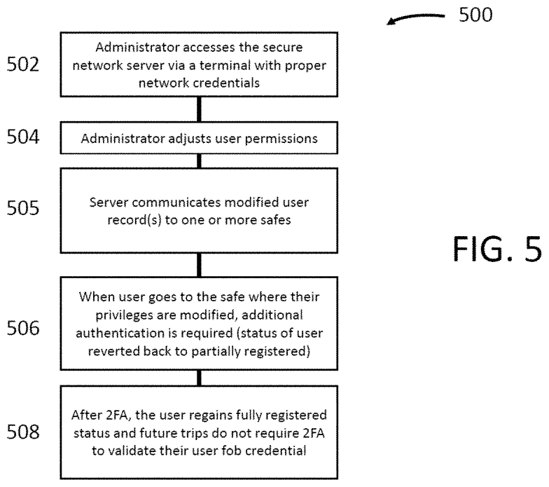

Referring now to FIG. 5, if an administrator wishes to change the permissions of a user for one or more safes, he or she can do so without needing the user's electronic fob utilizing process 500 in the following manner.

In step 502, the administrator accesses the secure networked database 152 via an access point 150 with proper network credentials.

In step 504, the administrator adjusts the permissions of a user. Examples include changing privileges of the user at a particular safe or group of safes or changing the safes for which the user has access.

In step 505, the server communicates any user record modifications to the safes impacted.

In step 506, after the changes are made by the administrator, when the user goes to a safe where his privileges are modified to allow increased access, the safe requires additional authentication through one of the previously covered three 2FA methods at the safe. If the user's privileges are decreased or eliminated, preferably no 2FA method is necessary and the safe reduces or eliminates access privileges accordingly. In instances where increased control over any user record changes are desired, the same 2FA method can be imposed.

In step 508, once a new user is fully registered or after a user is validated to have increased permissions, the 2FA requirement for that user is removed to allow for expedient future credential validation. This removal of the 2FA requirement for one user does not however preclude the use of 2FA methods involving a second individual presenting their credentials to perform security-sensitive activities which will often be the case.

In a process 600 in accordance with a second embodiment of the invention shown in FIG. 6, a user is added at the networked safe locally, without pre-registration from a central administrator. The steps for complete registration at the safe in this method 600 and the user experience in this second embodiment are detailed in FIGS. 6-9 as follows.

In process 600 of full registration at the safe, in step 601, the user is prompted for authentication.

The user to be newly added is authenticated using one of three procedures of authentication 602A, 602B or 602C (collectively 602). According to procedure 602A, log in is made with a role or permissions greater than those to be added. For example, the new user's supervisor may log in with a higher permission fob or loan that fob to the new user for the day when the new user is making a first visit to a safe or safes.

According to procedure 602B, log in is authenticated with a temporary code.

According to procedure 602C, log in is authenticated with an authenticator fob.

In step 604, the new user selects from a safe menu the option to add a new user at the safe with a particular role, such as collecting cash or performing maintenance. This list of available roles is restricted based on permission level of partner user in method 602A, the permission level associated with the OTC method 602B, or based on configuration of authentication fob used in method 602C.

In step 606, the new user presents the fob at the safe.

In step 608, the safe reads the fob's user identification and encrypted password.

In step 610, the encrypted password is verified based on user identification and shared secrets between the safe and the programming terminal 160.

In step 612, the user adds any metadata to associate with the recognized fob and the safe saves it as a user record.

In step 614, the safe transmits a new user record to the networked database 152 along with the 2FA authorized method used (and with the previously registered user ID from step 602A if applicable).

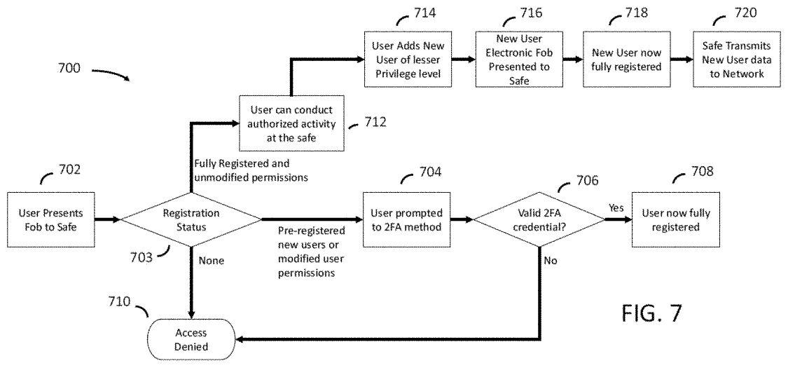

Upon successful transmission of the new user record, the registration process is complete in step 616 and the new user fob is fully registered and may be used at the safe in the future as discussed further in connection with FIGS. 7-9.

Step 610 above assumes the preferred previously discussed fob password was derived from the user ID and shared secrets between the safe and the programming terminal 160. If the encrypted password is arbitrarily derived, then it too needs to be included in the user record.

The above steps can be further simplified if the recognition of the authentication fob in step 601C prompts the safe immediately to add a new user with an assumed role.

Upgrading a user's permissions to a higher level of access can also be performed locally at the safe. This upgrade requires either a temporary code, an appropriately configured authentication fob, or the presentation of a credential of higher permission level to the new upgraded access level being granted.

As shown in process 700 of FIG. 7, in step 702, the user presents a fob to the safe.

In step 703, the fob's and user's registration status is determined.

If the user is a pre-registered new user or has modified user permissions, in step 704, the safe prompts the user for authentication following one of the previously discussed 2FA methods 601A-601C at the safe.

In step 706, if the user presents a valid 2FA credential, then the new user and the fob are fully registered.

If at step 703 or step 706, the registration status is none or valid 2FA authentication is not presented, then access is denied in step 710.

If at step 703, the registration status is determined to be fully registered and unmodified permissions, then in step 712, the user can conduct authorized activity at the safe.

One example is illustrated in step 714, in which the user adds a new user of lesser privilege level.

In step 716, the new user electronic fob is presented to the safe and in step 718, the new user is fully registered.

The safe transmits new user data to the networked database 152 in step 720.

FIG. 8 shows a process 800 which illustrates a user experience at the safe with an authentication fob. In step 802, an authentication fob is presented at the safe. If in step 804, the authentication fob is not recognized, then access is denied in step 806. If at step 804, the authentication fob is recognized, the user is prompted in step 808 to enter user data. In step 810, the new user electronic fob is presented to the safe, and in step 812, the new user is now fully registered. In step 814, the safe transmits the new user data to the network.

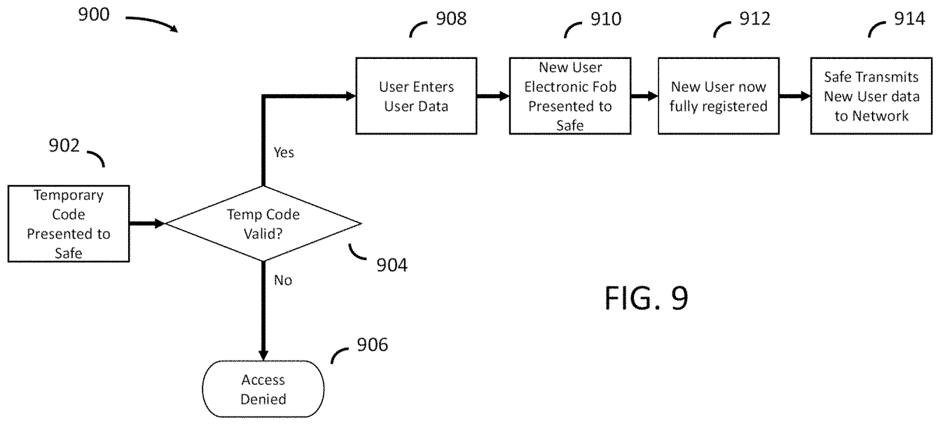

In process 900 of FIG. 9, the user experience at the safe using a temporary code is illustrated. In step 902, a temporary code is presented to the safe. For example, the temporary code is keyed in using a keypad such as 1014 in FIG. 10 after selecting an add new user mode. In step 904, if the temporary code is not recognized as valid, then access is denied in step 906. If in step 904 the temporary code is recognized as valid, then in step 908, the user is prompted to enter user data. In step 910, the new user electronic fob is presented to the safe. In step 912, the new user is now fully registered. In step 914, the safe transmits the new user data to the network.

In contrast with the first embodiment's two-part registration process, process 600 does not accept a peer-level credential to add users, they must be of higher permission level. This process also has a drawback of entering user metadata at the safe which may be more tedious for larger enterprises where that data is easier to port from a database. For smaller CIT operations or operations with less central administration staff in place, this second method more easily accommodates ad hoc user creation while still maintaining similar levels of protection against malicious intent.

FIG. 10 shows an exemplary programmed control processor and illustrative peripherals of a control system 1000 for one embodiment implementing an electronic safe, such as one of the safes 110 of FIG. 1. While an electronic drop safe is shown, it will be recognized that the present invention may suitably be employed with a wide range of electronic smart safes characterized by having electronic locks to gain access to valuables and data stored therein, as well as access to provide service to safe components; time stamps to record events such as deposits, service calls, safe openings, collections and the like; and at least part time network communication with a central server or database. Further details of electronic safes and electronic locks for safes with which the present invention may be advantageously adapted and employed are found in U.S. Patent Application Publication Nos. 2002/0063034; 2004/0046018; 2011/0279225; 2011/0011927; 2016/0010939; 2020/0056218; and U.S. Pat. Nos. 7,516,832; 7,779,983; 8,770,372; and 10,584,515 all of which are assigned to the assignee of the present invention and incorporated by reference herein in their entirety.

In FIG. 10, processor 1010 drives display 1012 to display prompts to a user including a prompt to a first-time user for authentication, a menu of roles and the like. A keypad or keyboard 1014 is utilized by the user to enter an OTC, user metadata and the like.

An electronic lock or locks 1016 are controlled by processor 1010 to control access to valuables, such as cash, components that require servicing and the like. Preferably, a BLE transmitter and receiver 1018 is controlled by processor 1010 to receive communications from a fob, such as one of the fobs 180 or an authenticator fob 190. Fob transceiver 1018 alternatively can take the form of other RF transceivers compatible with the various RF fobs described and may be one and the same as the network transceiver 1019. The network connection 1019 is used to communicate with a network such as network 120 to communicate details of new user fob registration and the like. Network transceiver 1019 is preferably a cellular modem, but could be other connection means such as an Ethernet connection, or a WiFi connection to the database 152.

Processor 1010 receives clock inputs from clock 1030 which it employs in time stamping events deemed to be significant, such as cash collection, cash deposits, service events, fob registration, permission modifications and the like. Control system 1000 may also optionally include a physical fob connection such as a iButton port or USB port 1050. A bill validator and stacker 1060 may be advantageously employed to validate currency inserted into an electronic safe and stack same for easy pick up. The time of insertion of currency and the amount of any such insertion are reported to the processor 1010 and these events are time stamped as well as ay door openings for service of the safe.

Control system also includes memory including program storage 1020 and data storage 1040. The exemplary program storage 1020 includes program instructions arranged in modules, such as a module 1021 to control the processor 1010 to determine the validity of temporary codes, a module 1022 to control the processor to determine the validity of an administrator fob, a module 1023 to determine validity of either a higher permission fob or a same permission fob, a module 1024 to control the processor to recognize and authenticate a new user fob. A module 1025 to manage collection and storage of time stamp data, and a module 1026 to collect data regarding stored valuables.

The data storage memory 1040 stores data fields including filed 1042 storing time stamp data, field 1044 storing user data, field 1046 storing fob data, and field 1048 storing safe menu to add new user data, and field 1049 the new controller configuration flag for accepting a list of users as fully registered while asserted.

While the disclosure has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the disclosure as hereinafter claimed is intended to be broadly construed and interpreted, as including all such variations, modifications and alternative embodiments, within its spirit and scope.

What is claimed is:

1. A system comprising a networked central database, an electronic safe, and an electronic user fob:
the networked central database storing safe users and associated unique identification numbers;
the electronic safe controlled by an electronic safe controller;
an electronic fob reader for reading electronic user fobs, wherein the electronic safe is at least in occasional communication with the networked central database by way of a network connection, a list of allowed safe users and corresponding access rights are exchanged from the networked central database to the safe, the controller authenticates safe users for the purpose of granting access to secure data stored within the controller, door access, or both;
the electronic user fob contains at least the user's unique identification number, and wherein, a multi-factor authentication method is required at the safe to accept the electronic user fob on the first access attempt by that fob at that safe, a first factor authentication being presentation of the electronic user fob at the electronic safe; and
the user is authenticated with the electronic user fob alone on subsequent electronic safe access.

2. The system of claim 1 where the multi-factor authentication method includes the presentation of a temporary code.

3. The system of claim 1 where the multi-factor authentication method includes the presentation of a recognized electronic fob having a similar or higher privilege level as the electronic user fob.

4. The system of claim 1 wherein the electronic fob has a uniquely programmed and unalterable identification number (fob id) which is employed as the user's unique identification number.

5. The system of claim 4 wherein the fob id is a unique media access control number having at least 48 bits.

6. The system of claim 1 wherein when user permissions for to electronic fob are to be increased, an authentication fob is presented to and recognized by the electronic safe to confirm the increased permissions for a first time.

7. The system of claim 6 where upon subsequent presentation of the electronic fob, the increased permissions are available.

8. A system comprising a networked central database, an electronic safe, an electronic user fob, and an authentication fob:
the networked central database storing electronic safe users and associated unique identification numbers;
the electronic safe controlled by an electronic safe controller and having an electronic fob reader for reading electronic user fobs;
the electronic safe communicating at least occasionally with the central networked database by way of a network connection, wherein
a list of allowed safe users and corresponding access rights are exchanged from the networked central database through the network to the electronic safe; the controller authenticates safe users for the purpose of granting access to secure data stored within the controller, door access, or both;
the electronic user fob contains at least the user's unique identification number;
an authentication fob is used to expedite the authentication of new electronic user fobs by requiring presentation of the authentication fob at the safe to accept the electronic user fob on the first access attempt by that fob at that safe, and the user may authenticate with the electronic user fob alone on subsequent safe access.

9. A system comprising a networked central database, an electronic safe, and an electronic user fob:
the networked central database stores safe users and associated unique identification numbers;
the electronic safe is controlled by an electronic safe controller, and has an electronic fob reader for reading electronic user fobs;
the electronic safe is at least in occasional communication with the networked central database by way of a network, whereby a list of allowed safe users and corresponding access rights are exchanged from the networked central database over the network to the safe, the controller authenticates safe users for the purpose of granting access to secure data stored within the controller, door access, or both; and
the electronic user fob stores at least the user's unique identification number, wherein, a multi-factor authentication method is required at the safe to accept the electronic user fob if the permissions of that user have been modified since the fob was last used at that safe, and the user may authenticate with the electronic user fob alone on subsequent safe accesses.

10. The system of claim 9 further comprising:
a programming terminal having registration software and a fob programmer utilized to program electronic user fobs and authentication fobs.

11. The system of claim 10 wherein the programming terminal writes an encrypted password into the electronic fob.

12. The system of claim 11 wherein the encrypted password is derived form a unique fob identification number and a shared secret shared with the electronic safe.
